(19) United States
(12) Patent Application Publication
(10) Pub. No.: US 2014/0269296 A1
(43) Pub. Date: Sep. 18, 2014

(54) Systems and Methods of Bundled Label Switch Path for Load Splitting

(71) Applicant: COX COMMUNICATIONS, INC., Atlanta, GA (US)

(72) Inventor: Mazen Khaddam, Cumming, GA (US)

(73) Assignee: COX COMMUNICATIONS, INC., Atlanta, GA (US)

(21) Appl. No.: 13/802,016

(22) Filed: Mar. 13, 2013

(51) Int. Cl. H04L 12/70

(52) U.S. Cl. CPC H04L 47/125
USPC 370/235

(57) ABSTRACT

In example embodiments of the systems and methods of multipath load balancing disclosed herein, a bundle of packets for transmission over a network backbone is transformed into N parallel bundles. The multi-path model is composed of its N constituent legs that are signaled between the same ingress/egress node pair such that each leg can potentially carry 1/N of the traffic rate of the original route. The multi-path legs can be easily identified based on their placement or power in the backbone due to their ability to carry the largest traffic volume between important or critical nodes. The number of parallel legs that the bundle is composed of may be set based on the average nodal degree of connectivity in the network backbone.

### TECHNICAL FIELD

The present disclosure is generally related to telecommunications and, more particularly, is related to digital networks.

### BACKGROUND

Computer networks provide a mechanism for transferring information between various locations. Large computer networks may be extended around the world to interconnect multiple geographic sites and thousands of hosts. Additionally, various types of internetworking devices have been developed to permit nodes of one network to communicate with nodes of other networks. These devices are often referred to as routers or gateways.

To transfer information from one node on a network to a node or group of nodes on another network, it is necessary to determine a path through the interconnected series of links and networks for the information to be propagated. Various routing protocols have been developed for calculating routes across interconnected networks.

In the currently-evolving network environments, there is an increasing requirement for flexible connectivity between switching nodes for the carriage of payload, control and management traffic. Switching nodes are becoming more and more complex. The rapid growth of packetized data traffic requires that switching nodes perform multi-layer switching functions. There are heretofore unaddressed needs with previous routing solutions.

### SUMMARY

Example embodiments of the present disclosure provide systems of bundled label switch path for load splitting. Briefly described, in architecture, one example embodiment of the system, among others, can be implemented as follows: a receiver configured to receive a bundle of packets to be transmitted from a first point to a second point across a digital network, the digital network comprising multiple route legs from the first point to the second point; a processor configured to determine a number of clusters to transform the bundle into; and a transmitter configured to transmit each of the clusters on a different leg of the multiple route legs from the first point to the second point.

Embodiments of the present disclosure can also be viewed as providing methods for bundled label switch path for load splitting. In this regard, one embodiment of such a method, among others, can be broadly summarized by the following steps: receiving a bundle of packets to be transmitted from a first point to a second point across a digital network, the digital network comprising multiple route legs between the first point and the second point; determining a number of clusters to transform the bundle into; and transmitting each of the clusters on a different leg of the multiple route legs from the first point to the second point.

### BRIEF DESCRIPTION OF THE DRAWINGS

FIG. 1 is a system diagram of an example embodiment of a digital network.

FIG. 2 is a system diagram of an example embodiment of paths through the digital network of FIG. 1.

FIG. 3 is a system diagram of an example embodiment of a system of bundle label switch path for load splitting.

FIG. 4 is a flow diagram of an example embodiment of method of bundle label switch path for load splitting.

### DETAILED DESCRIPTION

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples. In a bundled LSP model, network transport costs are reduced. Instead of having one fat expensive path of large capacity to forward traffic between the nodes of interest, many smaller less expansive paths of different capacities may be used to forward the traffic. Bundled LSP may lower transport costs by efficiently utilizing statistical multiplexing traffic onto N equal and/or unequal label switch paths with associated costs of different capacities.

In example embodiments of a bundled label switch path system or method, a bundled LSP is composed of N independent LSPs with the appropriate priorities & same traffic metrics. The N LSPs are set up across shortest and/or non-shortest traffic engineering paths and are assigned the same metrics. The N LSPs may be applicable to best effort label switch paths.

Bundled LSPs may be set up across a shortest path during steady state. Weighted mapping of traffic to the bundled LSP based on available BW on a given path may lead to equal and/or unequal traffic paths. The LSPs may be sized by using an auto-bandwidth mechanism, a mechanism to measure the traffic demand between a given node pair of interest, and to size the label switch path accordingly. A bundled LSP is created by choosing appropriate paths followed by traffic engineering with traffic mapping decisions made on an ingress LSR. A bundled label switch has several advantages, including: minimizing the spare capacity cost, efficient bin packing and load balancing of smaller LSPs over available paths, use of multiple “good” paths instead of best or equal cost multi-paths, increased reliability by reducing risk via splitting/bifurcation of the traffic demands over N LSPs, reservation of the shortest paths for expedited forwarding & assured forwarding traffic applications based on label switch path priorities, sharing of segments or an entire path, providing partial protection at zero cost spare capacity, and use of facility-based link protection with zero size to minimize the spare capacity. Additionally, smaller LSPs (e.g., less than 5% of aggregate link bandwidth) allows routing within spare capacity under failure conditions.

Both existing and evolving routing protocols such as Asynchronous Transfer Mode (ATM), Forum Private Network-Network-Interface Specification (PNNI), Internet Open Shortest Path First (OSPF), and International Standards Organization (ISO) Open Systems Interface (OSI) identify a network node by the identify of its Route Server Element (RSE) which is some form of global address. Each RSE generates a routing table based on a preferred performance metric and a most recent topological view of the network. The table thus creates optimal routes for communication throughout the network. The RSE is responsible for administration of the algorithms that enable a node to keep its view of the network topology and performance metric current, referred to as Routing Information Exchange (RIE). This combination of responsibilities often necessitates the need for the RSE to act as a central focus for the routing of traffic through the switching node. The consequence of this is that the RSE becomes a bottleneck resource limiting the capacity and scalability of a distributed switch architecture.

Path selection schemes for routing digital data traffic among member stations or nodes of a multi-node packet-switched communications network typically employ some form of shortest path or minimal delay mechanism (commonly termed a path or link metric) for determining which route is to be used to transmit data from source to destination. One such scheme examines the path metrics of all possible links between source and destination and selects that path through the network whose total link metric represents the lowest transmission delay. By always basing its routing decision on the shortest path metric, this approach tends to introduce a substantial load imbalance among the nodes and subjects the shortest path to considerable traffic congestion.

In another scheme, an optimal traffic assignment mechanism is used to take advantage of the substantial capacity of the network that goes unused in the previous scheme. This scheme employs all paths through the network in an effort to minimize the average delay through the network. In accordance with this optimal traffic assignment approach, traffic from a source is subdivided into sub-portions which, in turn, are routed over a number of different source-to-destination highways. As traffic is subdivided and allocated to the different paths through the network, the average delay of the respective links is examined and adjustments are made (traffic is selectively moved to links having lower path delays) so as to iteratively converge upon an optimal (lowest) average delay through the network. While this latter approach improves upon the use of the resources of the network, producing a low steady state delay, it is not readily suited for use in a dynamic environment where the connectivity among nodes is subject to unpredictable transient degradation or failure.

Today, a company's network traffic may pass over a network backbone. A typical backbone, for example, may presently carry approximately 1.55 Terabits (Tb) per second. When traffic is routed over the backbone, the network carrier determines a preferred route to transmit the customer packets from input communication point to received communication point. Typically, it has been performed using multi-protocol traffic engineering. However, this only uses one path from point A to point B.

In an example embodiment of the disclosed systems and methods of bundled label switch load splitting, the traffic from point A to point B is broken into multiple smaller equal and/or non-equal paths (for example, a 5 Gb, a 10 Gb and a 15 Gb). The resources allocated in the backbone may be reduced if a bundle of packets is split into smaller clusters of packets. The traffic is split and examined on a multi-layer perspective. When the traffic is received, a modeling tool is used to run at least one algorithm to find the fastest transmission time for the bundle and a number of clusters of packets the bundle should be transformed into. Once the number of clusters is determined, the routing instructions are developed.

In an exemplary embodiment, the bundle of packets is split into two or three smaller clusters and the time to transport the packets across a particular leg of the backbone is measured to reduce the transport costs. The bundle of packets is being transmitted between Point A and Point B and in a particular scenario, traffic volume from point A to point B is relatively heavy such that sending the bundle in one container is not optimal. So, the bundle is split into multiple containers of different sizes and routed onto equal and/or unequal cost paths.

In example embodiments of the systems and methods of multipath load balancing disclosed herein, a bundle of packets for transmission over a network backbone is transformed into N parallel bundles. This results in maximizing utilization of resources and allows for minimization of spare or unused capacity. Increasing the maximum link utilization using a multipath model reduces the spare capacity needed to adsorb the rerouted traffic during fiber span failures. The bundled LSP is composed of its N constituent legs that are signaled between the same ingress/egress node pair such that each leg can potentially carry 1/N of the traffic rate of the original route. The bundled LSP legs can be easily identified based on their placement or power in the backbone due to their transitivity, assortativity, and connectedness to carry the largest traffic volume between important or critical nodes. The number of parallel legs that the bundle is composed of may be set based on the average nodal degree of connectivity in the network backbone. It can also be based on the maximum number of allowed legs or the maximum size of a given leg between the node pairs.

In an example implementation, for a given time interval the bundled traffic demand rate is B Gbps such that B is greater or equal to 20% of the given link size. The consequence of that is the effective maximum link utilization must be less than or equal to 75% in order to accommodate the bundled traffic during a fiber span failure. In this example, a particular path in the backbone has 15 Gbps bandwidth capability, a leg in that path has failed, and the average number of hops in the path in four. To reroute that bundle at 100% of its subscription, a path is located such that each hop has available BW of at least 15 Gbps. It may be infeasible to find the requested bandwidth on a single path.

Example routing path 100 is provided in FIG. 1. Routing path 100 from node A 110 to node B 180 includes node 120, node 130, node 140, node 150, node 160, and node 170. Each of the node links that are connected to the source and sink of node A 110 have the same link capacities. The maximum available bandwidth per bundle is denoted as MAB. At time T1 due to some failure, node A 110 reroutes a bundle of packets (LSPx) with bandwidth constraint of 20 Gbps. Node A 110 may not be able to satisfy the LSPx BW demand due to lack of available BW to admit the bundle of packets at 100% of its subscribed bandwidth. If LSPx is transformed into three parallel LSPs (LSP1, LSP2, LSP3), for example, the bundles of LSPs may be transmitted at 100% of its bandwidth constraint.

During steady state, this model may not offer any significant advantages because the LSPs will be able to set up corresponding to the bandwidth constraints because the network is dimensioned to handle that event. The bundled LSP model will be advantageous, as a non-limiting example, during failed fiber span or during unpredictable traffic shifts due to flash crowds and border gateway protocol (BGP) rerouting. The bundle LSP model has advantages on spare capacity such as minimizing spare capacity, traffic load balancing, efficient bin packing, and increased reliability. According to the FCC, example metro networks experience 13 cuts per year per 1000 miles of fiber. Long-haul networks experience about 3 cuts per year per 1000 miles of fiber. For long-haul networks of 30000 route-miles of fiber, this implies one fiber cut every four days. So the bundled LSP will be utilized quite frequently.

The spare capacity needed may be minimized. In a capacitated network the maximum link utilization may be as high as 85%. The cost of spare capacity will be reduced in the verification and validation section because the links have the ability to run at much higher utilization levels. The cost of spare capacity is a function of network topology and is composed of optical cost and router cost.

Traffic load balancing may be achieved since N LSPs can carry the traffic between the same ingress-egress node pair. Equal cost load balancing may be achieved such that the LSPs will be assigned the same traffic engineering (TE) metric.

Efficient bin packing may be achieved by assigning traffic to a large number of paths or bins as opposed to the shortest path or bin. In this example embodiment, a constraint-shortest-path algorithm may be replaced with K-shortest paths since N paths may be utilized to satisfy the bundle LSP bandwidth constraint.

Increased reliability may be achieved since some member of the multi-path LSP may be routed over fiber-disjoint paths. It is likely that some member of the multi-path LSP may take paths that are maximally disjoint with respect to the other members. So in the case of failure, some of the LSPs may be rerouted. In legacy networks, if this case arises, that LSP can stay indefinitely on the bypass LSP, and in the event the bypass is down, the LSP will utilize interior-gateway-protocol (IGP) short cuts due to label distribution protocol (LDP) into resource reservation protocol (RSVP) tunneling. That LSP may not meet its bandwidth constraint. The cost of spare capacity is a function of network topology and composed of optical cost and router cost. In a backbone, of today the failed capacity may belong to the closed interval of Gbps.

As provided in FIGS. 2 and 3, the backbone traffic may be characterized as heavy-tail such that a majority of the LSP carry insignificant amounts of traffic. As noted before, 20 percent of the LSPs may carry about 70% of the aggregate traffic over a particular backbone, which lends itself to multi-path TE LSP transformation. The 20/70 distribution makes an apt case for statistical multiplexing in a backbone. In an example implementation, the one or more of the following steps may be utilized: examine the cost savings for various bundle LSP sizes; sampling a traffic demand matrix at its 95th percentile; utilizing facility-based link protection for fast recovery time with zero BW LSPs and shared risk link groups (SRLG) to guide constrained shortest path first (CSPF) for the bypass computations; using multiprotocol label switching (MPLS) auto-bandwidth as an LSP sizing mechanism; using class-based LSP forwarding for expedited forwarding (EF), assured forwarding (AF) and best effort (BE) traffic; and shared backup path restoration for cost efficiency.

One side effect of the systems and methods of bundled LSP disclosed herein is increased latency since the bundled LSP model will utilize all of the available capacity that is available after failure in the network because of its flexibility and efficiency. The best effort traffic carried via bundled LSP may incur increased latency.

In FIG. 2, a model of a network is composed of eight routers and MPLS traffic engineering is configured on all nodes. Each node shows the Minimum Available Bandwidth (MAB) per link. For example, the link between RTR1 and RTR5 has an MAB value of 10 Gbps. FIG. 2 reflects the state of the network at time called T0. In FIG. 3, at time T1 such that T1 is greater than T0, due to a fiber cut, Router A may signal a traffic engineering LSP of size 20 Gbps to router Z. The LSP will fail due lack of bandwidth. Three different paths are available in FIG. 3 such that path1 via RTR1, RTR2, and RTR3 has minimum available 10 Gbps, path2 via RTR1, RTR4, and RTR3 has minimum available bandwidth of 8 Gbps and path3 via RTR1, RTR5, and RTR6 has minimum available bandwidth of 8 Gbps.

An example embodiment of methods of a bundled LSP is applied in FIG. 3, in which the 20 G LSP is transformed into three different LSPs of different sizes and mapped onto equal cost and/or unequal cost paths. The bundled LSP will succeed since it is transformed and mapped adaptively onto the network as: path1 via RTR1, RTR2, RTR3 where LSP size is set to 8 gbps; path2 via RTR1, RTR4, RTR3 where the LSP size is set to 6 Gbps; and path3 via RTR1, RTR5, RTR6 where the LSP size is set to 6 Gbps.

In order to optimize a deployment according to the methods of multipath load balancing disclosed herein, the network may be prepared by ensuring that the same TE metric is assigned to all clusters of a given bundle LSP in order to achieve equal-cost load balancing. Additionally, the maximum number of LSPs that are resolved to the same next-hop will be limited. The CSPF tie-breaker is set to RANDOM to yield the best results. Moreover, the best effort traffic may be the only traffic configured to utilize the bundle LSP model. The best effort traffic may be considered to be the dominant traffic over the backbone.

FIG. 4 provides a flow chart of an example embodiment of a method of multipath load balancing. In block 410 of method 400, a bundle of packets to be transmitted from a first point to a second point across a digital network is received. The digital network comprises multiple routing legs from the first point to the second point. In block 420, a number of clusters to transform the bundle of packets into is determined. In block 430 each of the clusters is transmitted from the first point to the second point on a different leg of the multiple route legs.

The flow chart of FIG. 4 shows the architecture, functionality, and operation of a possible implementation of the multipath load balancing software. In this regard, each block represents a module, segment, or portion of code, which comprises one or more executable instructions for implementing the specified logical function(s). It should also be noted that in some alternative implementations, the functions noted in the blocks may occur out of the order noted in FIG. 4. For example, two blocks shown in succession in FIG. 4 may in fact be executed substantially concurrently or the blocks may sometimes be executed in the reverse order, depending upon the functionality involved. Any process descriptions or blocks in flow charts should be understood as representing modules, segments, or portions of code which include one or more executable instructions for implementing specific logical functions or steps in the process, and alternate implementations are included within the scope of the example embodiments in which functions may be executed out of order from that shown or discussed, including substantially concurrently or in reverse order, depending on the functionality involved. In addition, the process descriptions or blocks in flow charts should be understood as representing decisions made by a hardware structure such as a state machine.

The logic of the example embodiment(s) can be implemented in hardware, software, firmware, or a combination thereof. In example embodiments, the logic is implemented in software or firmware that is stored in a memory and that is executed by a suitable instruction execution system. If implemented in hardware, as in an alternative embodiment, the logic can be implemented with any or a combination of the following technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc. In addition, the scope of the present disclosure includes embodying the functionality of the example embodiments disclosed herein in logic embodied in hardware or software-configured mediums.

Software embodiments, which comprise an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, or communicate the program for use by or in connection with the instruction execution system, apparatus, or device. The computer readable medium can be, for example but not limited to, an electronic, magnetic, optical, electromagnetic, infrared, or semiconductor system, apparatus, or device. More specific examples (a nonexhaustive list) of the computer-readable medium would include the following: a portable computer diskette (magnetic), a random access memory (RAM) (electronic), a read-only memory (ROM) (electronic), an erasable programmable read-only memory (EPROM or Flash memory) (electronic), and a portable compact disc read-only memory (CDROM) (optical). In addition, the scope of the present disclosure includes embodying the functionality of the example embodiments of the present disclosure in logic embodied in hardware or software-configured mediums.

Although the present invention has been described in detail, it should be understood that various changes, substitutions and alterations can be made thereto without departing from the spirit and scope of the invention as defined by the appended claims.

Therefore, at least the following is claimed:

1. A method comprising:
receiving a bundle of packets to be transmitted from a first point to a second point across a digital network, the digital network comprising multiple route legs between the first point and the second point;
determining a number of clusters to transform the bundle into; and
transmitting each of the clusters on a different leg of the multiple route legs from the first point to the second point.

2. The method of claim 1, further comprising transforming the bundle of packets into the determined number of clusters.

3. The method of claim 1, wherein determining the number of clusters comprises determining an average nodal degree of connectivity in the digital network.

4. The method of claim 1, wherein each of the clusters comprises a substantially equal number of packets.

5. The method of claim 1, further comprising assigning the same traffic engineering to each cluster of the number of clusters.

6. The method of claim 1, further comprising designating a maximum number of packets in a cluster.

7. The method of claim 1, further comprising setting a constrained shortest path first tie breaker to random.

8. A system comprising:
a receiver configured to receive a bundle of packets to be transmitted from a first point to a second point across a digital network, the digital network comprising multiple route legs from the first point to the second point;
a processor configured to determine a number of clusters to transform the bundle into; and
a transmitter configured to transmit each of the clusters on a different leg of the multiple route legs from the first point to the second point.

9. The system of claim 8, wherein the processor is further configured to transform the bundle of packets into the determined number of clusters.

10. The system of claim 8, wherein the processor is furthered configured to determine the number of clusters by determining an average nodal degree of connectivity in the digital network.

11. The system of claim 8, further comprising wherein each of the clusters comprises a substantially equal number of packets.

12. The system of claim 8, wherein the processor is further configured to assign the same TE metric to each cluster of the number of clusters.

13. The system of claim 8, wherein the processor is further configured to designate a maximum number of packets in a cluster.

14. The system of claim 8, wherein the processor is further configured to set a constrained shortest path first tie breaker to random.

15. A system, comprising:
a plurality of nodes in a digital network with multiple legs between a first point and a second point;
a multiplexing module configured to split a bundle of packets into a number of clusters and to transmit each of the clusters on a different leg of the multiple legs.

16. The system of claim 15, wherein the multiplexing module is further configured to determine the number of bundles by determining the average nodal degree of connectivity in the digital network.

17. The system of claim 15, wherein each of the clusters comprises a substantially equal number of packets.

18. The system of claim 15, wherein the multiplexing module is further configured to assign the same traffic engineering metric to each cluster of the number of clusters.

19. The system of claim 15, wherein the multiplexing module is further configured to designate a maximum number of packets in a cluster.

20. The system of claim 15, wherein the multiplexing module is further configured to set a constrained shortest path first tie breaker to random.
